(19) United States
(12) Patent Application Publication
(10) Pub. No.: US 2025/0361001 A1
(43) Pub. Date: Nov. 27, 2025

(54) ACOUSTIC ABSORPTION STRUCTURE COMPRISING AT LEAST ONE PARTITION SYSTEM POSITIONED IN AT LEAST ONE CELL TO FORM TWO TYPES OF RESONATORS, METHOD OF MANUFACTURING SUCH A STRUCTURE

(71) Applicants: Airbus SAS, BLAGNAC (FR); Airbus Operations SAS, TOULOUSE (FR)

(72) Inventors: Gregory ALBET, TOULOUSE (FR); Stéphane LE CLAINCHE, ROCHEFORT (FR); Benoit PRZYBYLA, TOULOUSE (FR); Manuel TEIGNE, ROCHEFORT (FR)

(21) Appl. No.: 19/213,307

(22) Filed: May 20, 2025

(30) Foreign Application Priority Data
May 24, 2024 (FR) FR2405298

(51) Int. Cl. B64C 1/40; B64F 5/10

(52) U.S. Cl. CPC B64C 1/40; B64F 5/10

(57) ABSTRACT

An acoustic absorption structure including a cellular structure that includes at least one cell delimited by at least one wall and at least one partition system. The system includes at least one subsystem positioned in the cell and adapted to divide it into at least two cavities and at least one tongue connected to the subsystem and having a hook shape straddling one of the first and second edges of the wall. The tongue facilitates installing and retaining each partition system in the cell.

### CROSS-REFERENCES TO RELATED APPLICATIONS

This application claims the benefit of French Patent Application Number FR2405298 filed on May 24, 2024, the entire disclosure of which is incorporated herein by way of reference.

### FIELD OF THE INVENTION

The present invention relates to an acoustic absorption structure including at least one partition system positioned in at least one cell to form two types of resonator and to a method of producing such a structure.

### BACKGROUND OF THE INVENTION

In one prior art embodiment an aircraft propulsion system comprises a nacelle and a bypass turbojet engine positioned inside the nacelle which has, at the rear, a primary jet pipe through which the burned gases resulting from combustion are evacuated. This primary jet pipe includes at the level of its skin an acoustic absorption structure for attenuating noise in a plurality of frequency bands, such as noise linked to combustion (300-1000 Hz) and noise linked to functioning of the turbine (≤4,000 Hz) for example.

In a first embodiment an acoustic absorption structure includes at least one cellular structure positioned between an acoustically resistive layer in contact with a medium in which acoustic waves propagate and a reflective layer. This embodiment enables a quarter-wave resonator to be obtained adapted to attenuate sound waves at high frequencies. In this embodiment the range of frequencies of the attenuated sound waves depends on the height of the cells of the cellular structure.

In a second embodiment seen in FIG. 1 and described in the document FR3094668 an acoustic absorption structure 10 includes first and second cellular structures 12, 14 positioned between an acoustically resistive layer 16 in contact with a medium in which acoustic waves propagate and a reflective layer 18. This acoustic absorption structure 10 includes a separation layer 20 between the first and second cellular structures 12, 14, the first cellular structure 12 lying between the acoustically resistive layer 16 and the separation layer 20 and the second cellular structure 14 lying between the reflective layer 18 and the separation layer 20.

In the second embodiment the separation layer 20 includes orifices 22 enabling the cells of the first cellular structure 12 to communicate with those of the second cellular structure 14, each orifice 22 being extended by a tube 24 positioned in the second cellular structure 14.

The acoustic absorption structure 10 enables two types of resonator to be obtained, a first resonator of Helmholtz type at the level of the cells of the first cellular structure 12, adapted to attenuate sound waves at low frequencies, and a second resonator of quarter-wave type at the level of the cells of the second cellular structure 14, adapted to attenuate sound waves at high frequencies.

In this second embodiment each tube 24 is connected by a connection 24.1 to the separation layer and the first and second cellular structures 12, 14 are connected by connections 12.1, 14.1 to the separation layer 20. The cells of the first and second cellular structures 12, 14 must be perfectly aligned so that each cell of the first cellular structure 12 communicates with only one cell of the second cellular structure 14.

Although this second embodiment enables attenuation of sound waves over wider ranges of frequency it is not entirely satisfactory because the large number of connections increases the weight of the acoustic absorption structure 10 and complicates its method of production. The latter method is all the more complicated to use as the cells of the first and second cellular structures have to be perfectly aligned to obtain optimal operation. Another disadvantage is that such an acoustic absorption structure necessitates at least two drainage systems, one for each of the first and second cellular structures 12, 14, which tends to complicate the acoustic absorption structure. Finally, a curved profile of the acoustic absorption structure 10 proves difficult to obtain given the connections 12.1, 14.1 that connect the edges of the walls delimiting the cells of the first and second cellular walls 12, 14 to the separation layer 20.

In a third embodiment described in the document U.S. Pat. No. 3,952,831 an acoustic absorption structure includes at least one cellular structure positioned between an acoustically resistive layer and a reflective layer and a plurality of porous partitions positioned in the cells of the cellular structure and spaced from the acoustically resistive and reflective layers. These porous partitions are approximately plane and parallel to the acoustically resistive and reflective layers. In one embodiment two partitions are connected by two joining partitions that span a wall of the cellular structure and are pressed against it. This solution is not entirely satisfactory because it rules out obtaining two types of resonator, which limits the number of acoustic attenuation characteristics that can be adjusted independently of one another.

In a fourth embodiment described in the documents US2020/265821 and FR3082987 an acoustic attenuation structure includes at least one cellular structure positioned between an acoustically resistive layer and a reflective layer and a plurality of frustoconical partitions positioned in the cells of the cellular structure. Each frustoconical partition is connected at the level of its largest section to a skin pressed against the acoustically resistive layer and has at the level of its smallest section an orifice spaced from the reflective layer. Although this solution enables production of two types of resonator, they are not entirely satisfactory because the partition necessarily has a flared shape between the orifice and the acoustically resistive layer, which limits the number of acoustic attenuation characteristics that can be adjusted independently of one another.

### SUMMARY OF THE INVENTION

The present invention aims to remedy some or all of the disadvantages of the prior art.

To this end, the invention has for object an acoustic absorption structure including an acoustically resistive layer, a reflective layer and at least one cellular structure between the acoustically resistive layer and in the reflective layer, the cellular structure including at least one cell delimited by at least one wall having first and second edges positioned at the level of the acoustically resistive layer and of the reflective layer and at least one partition system including at least one subsystem positioned in the cell and configured to divide the cell into at least two cavities that communicate with one another and form two types of resonator.

According to the invention the partition system includes at least one tongue that extends between first and second ends, the first end of the tongue being connected to the subsystem of the partition system, the second end of the tongue having a hook shape straddling one of the first and second edges of the wall. Additionally, each subsystem of the partition system includes:
at least one partition that has a perimeter and at least one through-orifice,
at least one first pipe in line with the through-orifice that extends between first and second ends, the first end being connected to the first or second partition, the second end being distant from the acoustically resistive layer or the reflective layer.

This solution facilitates positioning and retention of the partition systems in the cells of the cellular structure. Furthermore, the presence of a partition and a pipe makes it possible to increase the number of acoustic attenuation characteristics adjustable independently of one another.

In accordance with another feature at least one of the first and second edges of at least one wall onto which at least one tongue is hooked includes at least one first cutout sized to accommodate the second ends of the first and second tongues or the hook shape of the second end of the tongue, the second end of each tongue including at least one second cutout enabling the cells to communicate.

In accordance with another feature at least one partition has a rigid central part and a flexible peripheral part made of an elastically deformable material enabling the peripheral part to espouse the walls of the cell.

In accordance with another feature at least one partition is stuck to the walls of the cell all around its perimeter.

In accordance with another feature at least one partition is positioned in a plane at an angle between 5 and 70° to a plane parallel to the acoustically resistive layer.

In accordance with another feature the cellular structure includes at least first and second cells separated by a common wall. Additionally, the partition system includes first and second subsystems respectively positioned in the first and second cells, the partition system including first and second tongues, the second ends of the first and second tongues being connected to one another in such a manner as to constitute a hook shape straddling one of the first and second edges of the common wall.

In accordance with another feature each tongue has a length determined as a function of the acoustic characteristics required of the cavities of the cells.

In accordance with another feature the second end of each tongue is situated at the level of the acoustically resistive layer.

In accordance with another feature the second end of each tongue is situated at the level of the reflective layer.

In accordance with another feature at least one pipe is against at least one wall of the cell.

In accordance with another feature at least one pipe is distant from the walls of the cell.

The invention also has for object an aircraft including at least one acoustic absorption structure having any of the above features.

Finally, the invention also has for object a method of assembling an acoustic absorption structure having any of the above features. This assembly method includes a step of producing the partition systems, a step of producing the cellular structure, a step of installing the partition systems by inserting the partitions in the cells of the cellular structure, the hook shape of the second ends of the tongues of the partition systems straddling a wall of the cellular structure, and steps of installing the acoustically resistive layer and the reflective layer.

In accordance with another feature the assembly method includes prior to the step of installing the partition systems a step of producing first cutouts at the level of the first or second edge of the common walls, the second ends of the first and second tongues of each partition system cooperating with one of the first cutouts after the step of installing the partition systems.

### BRIEF DESCRIPTION OF THE DRAWINGS

Other features and advantages will emerge from the following description of the invention given by way of example only and with reference to the drawings, in which:

FIG. 1 depicting one prior art embodiment is a schematic section of an acoustic absorption structure,

FIG. 2 is a side view of an aircraft,

FIG. 3 is a longitudinal section of an aircraft propulsion system,

FIG. 4 depicting one embodiment of the invention is a perspective view of two cells of an acoustic absorption structure and a partition system straddling the two cells,

FIG. 5 is a perspective view of two cells and the partition system that can be seen in FIG. 4 during a step of insertion in the two cells,

FIG. 6 depicting one embodiment of the invention is a view from above of a cellular structure,

FIG. 7 depicting another embodiment of the invention is a longitudinal section of an acoustic absorption structure,

FIG. 8 depicting one embodiment of the invention is a perspective view of a curved acoustic absorption structure,

FIG. 9 depicting one embodiment of the invention is a longitudinal section of a cell and a partition system,

FIG. 10 depicting another embodiment of the invention is a longitudinal section of a cell and a partition system,

FIG. 11 depicting another embodiment of the invention is a longitudinal section of a cell and a partition system,

FIG. 12 depicting another embodiment of the invention is a longitudinal section of a cell and a partition system,

FIG. 13 depicting another embodiment of the invention is a perspective view of a part of an acoustic absorption structure,

FIG. 14 is a view in section on the plane P14 in FIG. 13,

FIG. 15 depicting another embodiment of the invention is a schematic section of a part of an acoustic absorption structure.

### DETAILED DESCRIPTION OF THE PREFERRED EMBODIMENTS

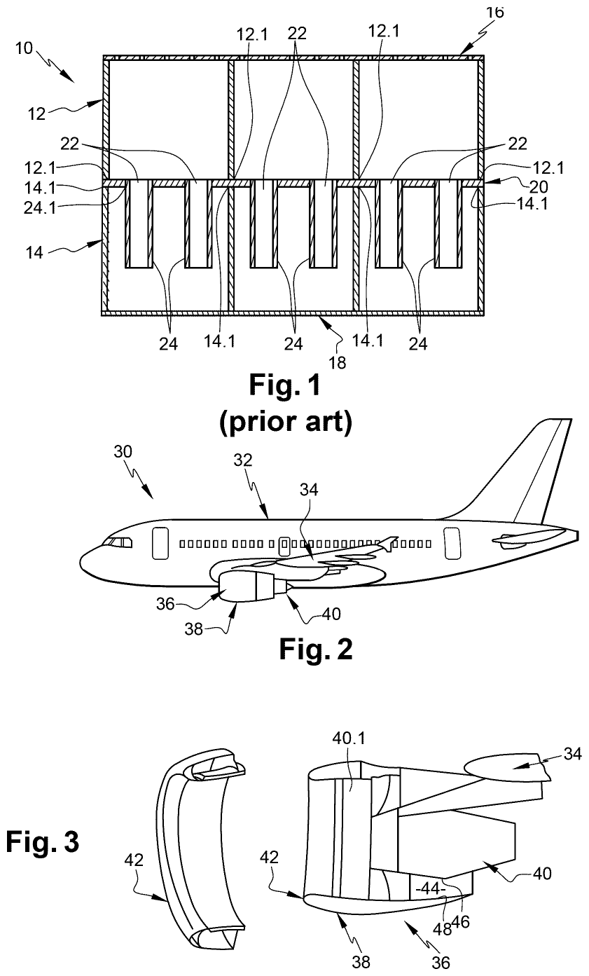

FIG. 2 represents an aircraft 30 that includes a fuselage 32, two wings 34 disposed on respective opposite sides of the fuselage 32 and propulsion systems 36 fixed under the wings 34. Each propulsion system 36 includes a nacelle 38 and an engine 40 positioned inside the nacelle 38.

In an embodiment seen in FIG. 3 the nacelle 38 includes at the front an air intake 42 that includes an interior pipe 44 configured to channel a flow of air in the direction of a fan 40.1 of the engine 40. The propulsion system 36 includes at the rear a jet pipe delimited by a first wall 46 attached to the engine 40 and a second wall 48 attached to the nacelle 38.

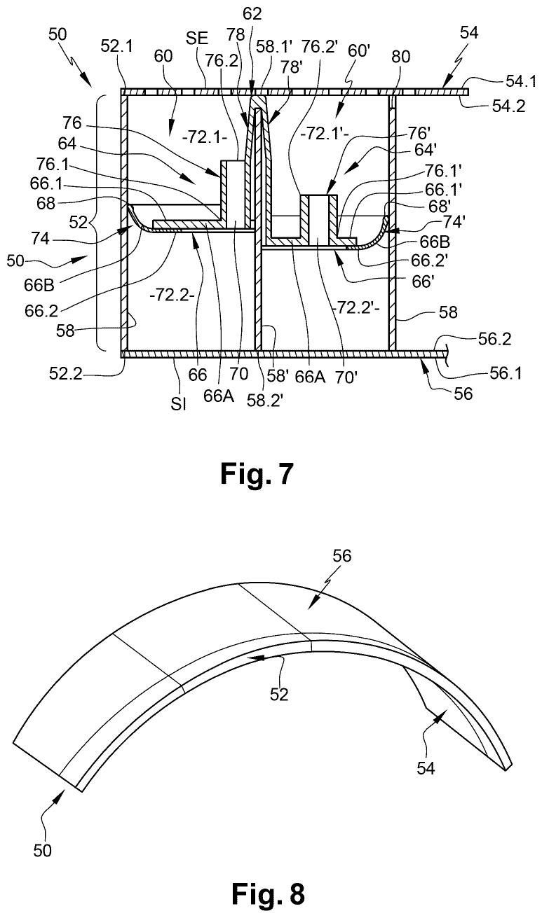

In one configuration the inner pipe 44 and the first and second walls 46, 48 each include at least one acoustic absorption structure 50 (seen in FIG. 7). Of course, the invention is not limited to these locations of the acoustic absorption structure 50. Thus the latter can be positioned at the level of walls that have a surface in contact with a medium in which sound waves propagate.

As depicted in FIG. 7 each acoustic absorption structure 50 includes an exterior surface SE in contact with a medium in which acoustic waves propagate and an interior surface SI opposite the exterior surface SE.

Each acoustic absorption structure 50 includes at least one cellular structure 52 between an acoustically resistive layer 54 permeable to sound waves and a reflective layer 56 impermeable to sound waves. The acoustically resistive layer 54 includes a first face 54.1 corresponding to the exterior surface SE and a second face 54.2 oriented toward and connected to the cellular structure 52. The reflective layer 56 has a first face 56.1 corresponding to the interior surface SI and a second face 56.2 oriented toward and connected to the cellular structure 52.

The acoustically resistive layer 54, the reflective layer 56, the connection between the acoustically resistive layer 54 and the cellular structure 52 and the connection between the reflective layer 56 and the cellular structure 52 are not described further because they can be identical to those of the prior art.

The cellular structure 52 extends between a first face 52.1 in contact with the acoustically resistive layer 54 and a second face 52.2 in contact with the reflective layer 56 and includes a multitude of walls 58 each of which has first and second edges respectively positioned at the level of the first and second faces 52.1, 52.2. These walls 58 are connected to one another so as to delimit cells 60 opening at the level of the first and second faces 52.1, 52.2.

In one embodiment the cellular structure 52 is a honeycomb structure, as depicted in FIG. 6. To give an idea of an order of magnitude, each cell 60 has a hexagonal cross section with six identical sides between 5 mm and 12 mm wide. Each cell 60 has a height (corresponding to the distance separating the first and second faces 52.1, 52.2) between 30 mm and 70 mm.

Of course, the invention is not limited to this embodiment of the cells 60. Each of them is open at first and second ends respectively blocked by the acoustically resistive layer 54 and the reflective layer 56. Each is delimited by at least one wall 58 and has a cross section delimited by the wall or walls 58.

The cellular structure 52 includes at least one partition 62 straddling the first and second cells 60, 60′, the partition system 62 including a first subsystem 64 positioned in the first cell 60 and a second subsystem 64′ positioned in the second cell 60′, the first and second cells being separated by a common wall 58′, the first and second subsystems 64, 64′ being separated by the common wall 58′ and connected to one another.

In one configuration the cellular structure 52 comprises a plurality of partition systems 62 each positioned in two adjacent cells 60, 60′. In one arrangement in at least one zone of the cellular structure 52 the latter includes first or second subsystems 64, 64′ in each cell 60, 60′.

The common wall 58′ separating the first and second cells 60, 60′ has first and second edges 58.1′, 58.2′ respectively oriented toward the acoustically resistive layer 54 and the reflective layer 56 and first and second lateral edges 58.3′, 58.4′ (seen in FIG. 6) substantially parallel to one another connecting the ends of the first and second edges 58.1′, 58.2′.

As depicted in FIG. 7 each of the first and second subsystems 64, 64′ of the partition system 62 includes at least one first or second partition 66, 66′ that has a perimeter 68, 68′ and at least one through-orifice 70, 70′ that passes through said first or second partition 66, 66′. When the first or second subsystem 64, 64′ of the partition system 62 is positioned in the first or second cell 60, 60′ the first or second partition 66, 66′ is in contact with the walls 58 of the first or second cell 60, 60′ over the entire perimeter 68, 68′ so as to be substantially sealed. The first or second partition 66, 66′ therefore divides the first or second cell 60, 60′ into upper and lower cavities 72.1, 72.2, 72.1′, 72.2′ that communicate with the through-orifice 70, 70′. The first or second partition 66, 66′ has first and second faces 66.1, 66.2, 66.1′, 66.2′ respectively oriented toward the upper and lower cavities 72.1, 72.2, 72.1′, 72.2′.

In one configuration at least one of the first and second partitions 66, 66′ includes a sealing system 74, 74′ that extends over all of the perimeter 68, 68′ to improve the seal between the first or second partition 66, 66′ and the walls 58 delimiting the first or second cell 60, 60′.

In one embodiment at least one of the first and second partitions 66, 66′ includes a rigid central part 66A and a flexible peripheral part 66B in the form of a membrane made of an elastically deformable material enabling the peripheral part 66B to espouse the shapes of the walls 58 of the first or second cell 60, 60′. Of course, the invention is not limited to this embodiment of the sealing system 74, 74′. At least one of the first and second partitions 66, 66′ could be stuck to the walls 58 of the cells 60, 60′ over the whole of its perimeter 68, 68′.

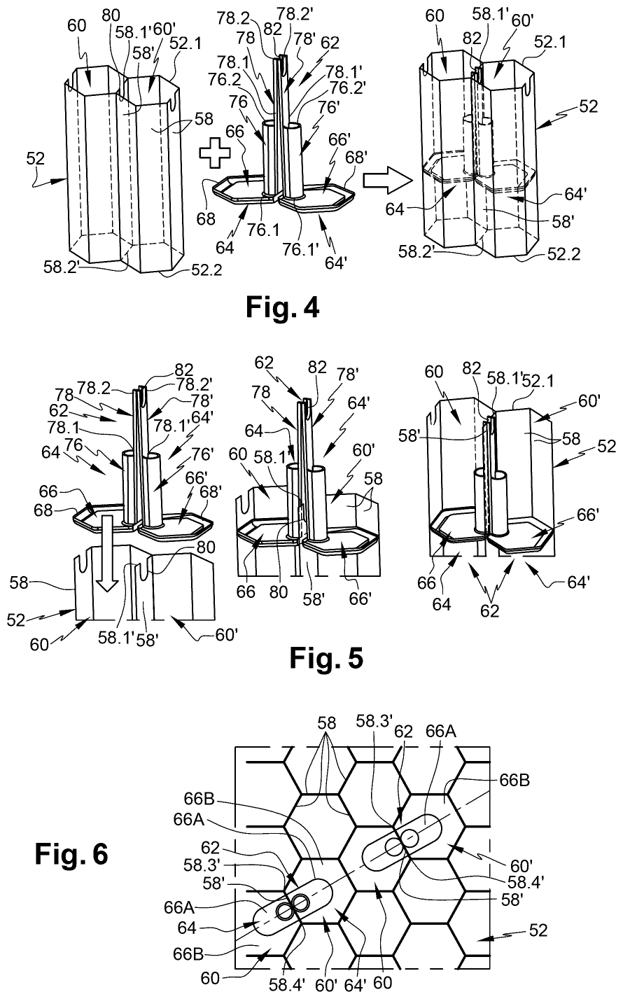

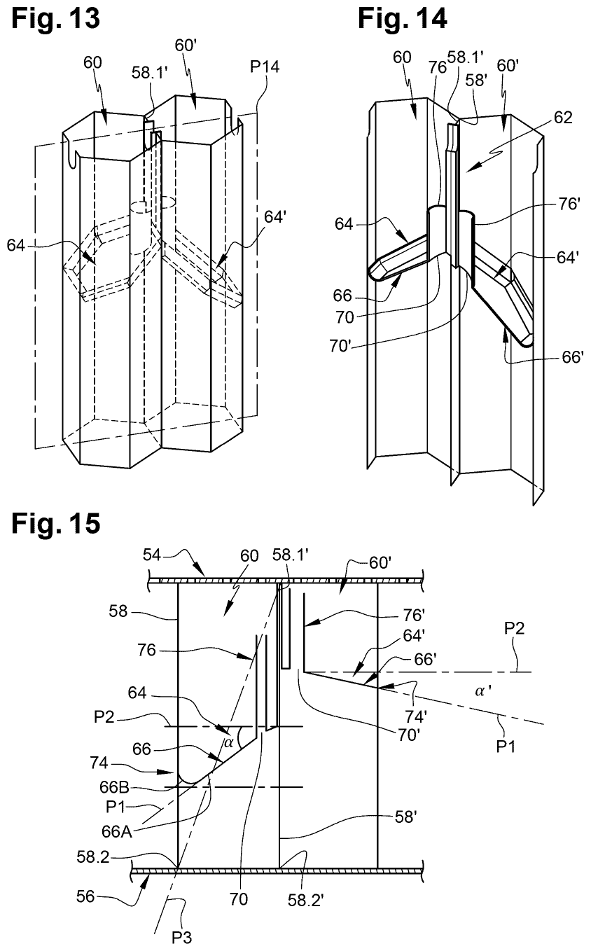

With the exception of its periphery, each partition 66, 66′ is substantially plane. In one embodiment with the exception of the through-orifice 70, 70′, each partition 66, 66′ is solid and is not porous. As depicted in FIGS. 4, 5, 7, 9 to 12 at least one partition 66, 66′ is substantially parallel to the acoustically resistive layer 54. In another embodiment seen in FIGS. 13 to 15 at least one partition 66, 66′ is positioned in a plane P1 at a non-zero angle α, α′ between 5 and 70° to a plane P2 parallel to the acoustically resistive layer 54. In one configuration the plane P1 is substantially parallel to a plane P3 passing through the first and second edges 58.1′, 58.2 at the end of two opposite walls 58′, 58 of the cell 60, 60′ in which the partition 66, 66′ is positioned. The partitions 66, 66′ of the same partition system 62 can be inclined in the same manner as depicted in FIGS. 13 and 14 or differently as depicted in FIG. 15.

In accordance with one particular feature of the invention each of the first and second subsystems 64, 64′ of the partition system 62 includes at least one first or second pipe 76, 76′ that extends between first and second ends 76.1, 76.2, 76.1′, 76.2′, the first end 76.1, 76.1′ being connected in sealed manner to the first or second partition 66, 66′ (to be more specific to the central part 66A of the first or second partition 66, 66′), the second end 76.2, 76.2′ being distant from the acoustically resistive layer 54 or the reflective layer 56. The first or second pipe 76, 76′ is positioned in the upper cavity 72.1, 72.1′ and in line with the through-orifice 70, 70′. The first or second pipe 76, 76′ has an inside diameter substantially equal to the diameter of the through-orifice 70, 70′.

In each of the subsystems 64, 64′ of the partition system 62 the first or second pipe 76, 76′ intersects at a non-zero angle the first or second partition 66, 66′.

Providing a partition 66, 66′ and a pipe 76, 76′ enables independent adjustment on the one hand of the dimensions and possibly the geometries of the upper and lower cavities 72.1, 72.2, 72.1′, 72.2′ separated by the partition 66, 66′ by adjusting the position of the latter and possibly its inclination and on the other hand the length and the interior section of the pipe 76, 76′, which makes it possible to increase the number of characteristics adjustable independently of one another of the partition system 62 and consequently the acoustic attenuation possibilities.

The partition 66, 66′ and the pipe 76, 76′ of each of the first and second subsystems 64, 64′ are made in one piece by an additive manufacturing process for example.

In another embodiment the partition 66, 66′ and the pipe 76, 76′ of each of the first and second subsystems 64, 64′ are produced separately and then connected together, for example welded together.

The partition 66, 66′ and the pipe 76, 76′ of each of the first and second subsystems 64, 64′ can be made of metal or any other appropriate material.

Of course, the invention is not limited to this embodiment of the first and second subsystems 64, 64′. Each of the first and second subsystems 64, 64′ is configured to divide each of the first and second cells 60, 60′ into at least two cavities 72.1, 72.2, 72.1′, 72.2′ that communicate with one another and form two types of resonator.

The partition system 62 includes first and second tongues 78, 78′ that extend between first and second ends 78.1, 78.2, 78.1′, 78.2′, the first end 78.1, 78.1′ of each first or second tongue 78, 78′ being connected to the partition 66, 66′ and/or to the pipe 76, 76′ of the first or second subsystem 64, 64′ of the partition system 62, the two ends 78.2, 78.2′ of the first and second tongues 78, 78′ being connected to one another to constitute a hook shape straddling one of the first and second edges 58.1′, 58.2′ of the common wall 58′.

In one arrangement each of the first and second tongues 78, 78′ is spaced from the first and second lateral edges 58.3′, 58.4′ of the common wall 58 and substantially centered relative to said first and said lateral edges 58.3′, 58.4′. Each of the first and second tongues 78, 78′ therefore has a width (the dimension parallel to the common wall 58′ and the acoustically resistive layer 54) less than the width of the common wall 58′ (the dimension corresponding to the distance separating the first and second lateral edges 58.3′, 58.4′).

In one embodiment the first ends 78.1, 78.1′ of the first and second tongues 78, 78′ are respectively connected to the second ends 76.2, 76.2′ of the first and second pipes 76, 76′. The first and second tongues 78, 78′ are therefore in line with the first and second pipes 76, 76′.

The first and second tongues 78, 78′ have lengths (the distances separating the first and second ends 78.1, 78.2, 78.1′, 78.2′) that are substantially identical. The length of the first and second tongues 78, 78′ is determined as a function of the acoustic characteristics required of the upper and lower cavities 72.1, 72.2, 72.1′, 72.2′.

In one arrangement the first and second pipes 76, 76′ are closely spaced and positioned on respective opposite sides of the common wall 58′. The first and second tongues 78, 78′ are closely spaced and positioned on respective opposite sides of the common wall 58′, the second ends 78.2, 78.2′ of the first and second tongues 78, 78′ being positioned at the level of the first edge 58.1′ of the common wall 58′.

In one configuration at least one of the first and second edges 58.1′, 58.2′ of at least one wall 58′ onto which at least one tongue 78, 78′ is hooked includes at least one first cut-out 80 sized to accommodate the second ends 78.2, 78.2′ of the first and second tongues 78, 78′ so that the latter, lodged in the first cut-out 80, do not project relative to the first or second face 52.1, 52.2 of the cellular structure 52. This first cut-out 80 is centered relative to the first and second lateral edges 58.3′, 58.4′ of the common wall 58′. This first cut-out 80 therefore contributes to centering the partition system 62 in the first and second cells. In one configuration each first cut-out 80 is U-shaped. In one arrangement this first cut-out 80 is provided for the drainage function.

In one embodiment the first and second ends 78.2, 78.2′ of the first and second tongues 78, 78′ include at least one second cut-out 82 enabling the first and second cells 60, 60′ to communicate. This second cut-out 82 is positioned in the first cut-out 80.

The second cut-outs 82 and the first cut-outs 80 not occupied by the first and second ends 78.2, 78.2′ of the first and second tongues 78, 78′ form a drainage network.

In a first arrangement the upper cavities 72.1, 72.1′ and the pipes 76, 76′ of each partition system 62 are situated between the first and second partitions 66, 66′ and the acoustically resistive layer 54, the first edge 58.1′ of the common wall 58′ and the second ends 78.2, 78.2′ of the first and second tongues 78, 78′ being situated at the level of the acoustically resistive layer 54. The lower cavities 72.2, 72.2′ are situated between the first and second partitions 66, 66′ and the reflective layer 56.

In a second arrangement the upper cavities 72.1, 72.1′ and the pipes 76, 76′ of each partition system 62 are situated between the first and second partitions 66, 66′ and the reflective layer 56, the first edge 58.1′ of the common wall 58′ and the second ends 78.2, 78.2′ of the first and second tongues 78, 78′ being situated at the level of the reflective layer 56. The lower cavities 72.2, 72.2′ are situated between the first and second partitions 66, 66′ and the acoustically resistive layer 54.

In an embodiment seen in FIGS. 4 and 5 the first and second subsystems 64, 64′ of at least one partition system 62 are symmetrical with respect to the common wall 58′ and the first and second tongues 78, 78′ are the same length. In another embodiment seen in FIG. 7 the first and second subsystems 64, 64′ of at least one partition system 62 are not symmetrical with respect to the common wall 58′ and/or the first and second tongues 78, 78′ are different lengths.

In one embodiment a method of assembling an acoustic absorption structure includes a step of producing the partition systems 62, a step of producing the cellular structure 52 and then a step of installing the partition systems 62 by inserting the partitions 66, 66′ in the cells 60, 60′ of the cellular structure 52, the hook shapes of the tongues 78, 78′ straddling one of the edges of the walls 58′ delimiting the cell 60.

Prior to the step of installing the partition systems 62 the assembly method includes a step of producing the first cut-outs 80 in such a manner as to form a drainage network after the step of installing the partition systems 62, the second ends 78.2, 78.2′ of the tongues 78, 78′ of each partition system 62 cooperating with one of the first cut-outs 80.

The assembly method includes, after installing all the partition systems 62, steps of installing the acoustically resistive layer 54 and the reflective layer 56. The assembly method can include a shaping step to obtain a curved acoustic absorption structure 50 as depicted in FIG. 8.

The partition system 62 enables simultaneous creation in two cells 60, 60′ of the upper and lower cavities 72.1, 72.1′, 72.2, 72.2′ in each of the cells 60, 60′, the upper cavities 72.1, 72.1′ each forming a Helmholtz type first resonator and the lower cavities 72.2, 72.2′ each forming a quarter-wave type resonator.

Providing for each partition system 62 first and second subsystems 64, 64′ respectively positioned in first and second cells 60, 60′ separated by a common wall 58′, the first and second subsystems 64, 64′ including first and second tongues 78, 78′ connected to one another and straddling the common wall 58′, facilitates installation of the partition systems and immobilization thereof in the cells 60, 60′. In accordance with the invention the partitions 66, 66′ are separated from the acoustically resistive layer 54 and the reflective layer 56 by a precise distance that depends on the lengths of the first and second tongues 78, 78′, those lengths being determined as a function of the acoustic characteristics required of the resonators.

Positioning the second ends 78.2, 78.2′ of the first and second tongues 78, 78′ in a first cut-out 80 simplifies positioning each partition system 62.

Of course, the invention is not limited to the embodiments described above.

The partition system 62 can include only one subsystem 64 positioned in one cell 60. As before the sub-system 64 includes a partition 66 that divides the cell 60 into two cavities 72.1, 72.2, a through-orifice 70 through which the two cavities 72.1, 72.2 communicate and a pipe 76 that extends the through-orifice 70.

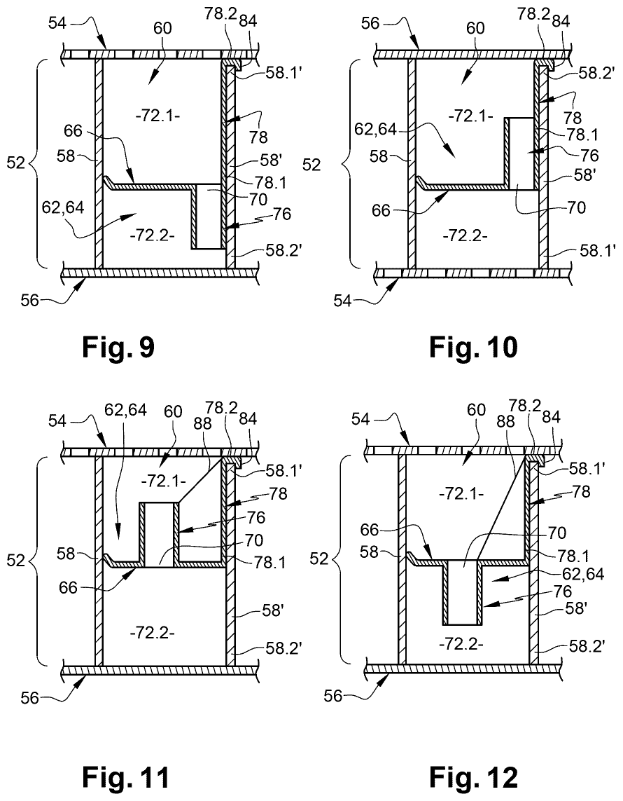

In a first arrangement at least one pipe 76 is positioned between the partition 66 and the acoustically resistive layer 54, as depicted in FIGS. 7 and 11. In a second arrangement the pipe 76 is positioned between the partition 66 and the reflective layer 56, as depicted in FIGS. 9, 10 and 12.

As appropriate, at least one pipe 76 is against at least one wall 58′ of the cell 60, as depicted in FIGS. 9 and 10, or distant from the walls 58, 58′ of the cell 60 and possibly centered, as depicted in FIGS. 11 and 12.

The partition system 62 includes at least one tongue 78 for connecting the subsystem 64 to one of the walls 58, 58′ of the cell 60. The tongue 78 can be connected to the wall 58′ against which the pipe 76 is positioned. Alternatively, the pipe 76 can be positioned against a wall 58′ other than that to which the tongue 78 is connected.

The pipe 76 and the tongue 78 can be positioned in the same cavity 72.1, 72.2, as depicted in FIGS. 7, 10 and 11, or in different cavities 72.1, 72.2 on either side of the partition 66, as depicted in FIGS. 9 and 12.

The tongue 78 has a first end 78.1 connected to the subsystem 64 and a second end 78.2 connected to one of the edges 58.1′, 58.2′ of the wall 58′. The first end 78.1 can be connected to the pipe 76, as depicted in FIGS. 9 and 10, or to the partition 66, as depicted in FIGS. 11 and 12.

In the embodiments seen in FIGS. 9 to 12 the second end 78.2 has a hook shape 84 straddling the edge 58.1′, 58.2′ of the wall 58′. Additionally, at least one of the first and second edges 58.1′, 58.2′ of the wall 58′ includes at least one cut-out 80 sized to accommodate the hook shape 84 of the second end 78.2 of the tongue 78. As before the second end 78.2 of each tongue 78 has at least one second cut-out enabling the first and second cells 60, 60′ to communicate.

To stiffen the tongue 78 the partition system 62 can include at least one rib 88 connecting the tongue 78 and the partition 66 and/or the pipe 76.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An acoustic absorption structure comprising:
an acoustically resistive layer;
a reflective layer; and
at least one cellular structure between the acoustically resistive layer and in the reflective layer, the at least one cellular structure including
at least one cell delimited by at least one wall having first and second edges positioned at a level of the acoustically resistive layer and of the reflective layer, and
at least one partition system including at least one subsystem positioned in the at least one cell and configured to divide the at least one cell into at least two cavities that communicate with one another and form two types of resonators,
wherein the at least one partition system includes at least one tongue that extends between first and second ends, the first end of the at least one tongue being connected to the at least one subsystem of the at least one partition system, the second end of the at least one tongue having a hook shape straddling one of the first and second edges of the at least one wall, and
wherein the at least one partition system further includes
at least one partition that has a perimeter and at least one through-orifice, and
at least one first pipe in line with the at least one through-orifice that extends between first and second ends, the first end of the at least one first pipe being connected to the at least one partition, the second end being distant from the acoustically resistive layer or the reflective layer.

2. The acoustic absorption structure as claimed in claim 1 wherein at least one of the first and second edges of the at least one wall onto which at least one tongue is hooked includes at least one first cutout sized to accommodate the second ends of the at least one tongue or the hook shape of the second end of the at least one tongue, the second end of the at least one tongue including at least one first cutout enabling the two cavities to communicate.

3. The acoustic absorption structure as claimed in claim 1, wherein the at least one partition has a rigid central part and a flexible peripheral part made of an elastically deformable material enabling the flexible peripheral part to espouse the at least one wall of the at least one cell.

4. The acoustic absorption structure as claimed in claim 1, wherein the at least one partition is stuck to the at least one wall of the at least one cell all around a perimeter.

5. The acoustic absorption structure as claimed in claim 1, wherein the at least one partition is positioned in a plane at an angle (α) between 5 and 70° to a plane parallel to the acoustically resistive layer.

6. The acoustic absorption structure as claimed in claim 1, wherein the at least one cellular structure includes first and second cells separated by a common wall,
wherein the at least one partition system includes first and second subsystems respectively positioned in the first and second cells, and
wherein the at least one partition system includes first and second tongues, the second ends of the first and second tongues being connected to one another in such a manner as to constitute a hook shape straddling one of a first and second edges of the common wall.

7. The acoustic absorption structure as claimed in claim 1, wherein the at least one tongue has a length determined as a function of one or more acoustic characteristics required of cavities of the at least one cell.

8. The acoustic absorption structure as claimed in claim 1, wherein the second end of the at least one tongue is situated at a level of the acoustically resistive layer.

9. The acoustic absorption structure as claimed in claim 1, wherein the second end of the at least one tongue is situated at a level of the reflective layer.

10. The acoustic absorption structure as claimed in claim 1, wherein the at least one first pipe is against the at least one wall of the at least one cell.

11. The acoustic absorption structure as claimed in claim 1, wherein the at least one pipe is distant from the at least one wall of the at least one cell.

12. An aircraft comprising:
at least one acoustic absorption structure as claimed in claim 1.

13. A method of assembling the acoustic absorption structure as claimed in claim 1, the method comprising:
producing the at least one partition system,
producing the at least one cellular structure,
installing the at least one partition system by inserting the at least one partition in the at least one cell of the at least one cellular structure, the hook shape of the second end of the at least one tongue of the at least one partition system straddling the at least one wall of the at least one cellular structure, and
installing the acoustically resistive layer and the reflective layer.

14. The method as claimed in claim 13, wherein prior to the installing the at least one partition system, the method includes:
producing a first cutout at a level of a first or second edge of the at least one wall,
the second end of the at least one tongue cooperating with the first cutout after the installing the at least one partition system.
